(19) United States
(12) Patent Application Publication
(10) Pub. No.: US 2007/0254623 A1
(43) Pub. Date: Nov. 1, 2007

(54) EMERGENCY MESSAGE DELIVERY FOR CELL PHONES

(75) Inventors: Steven J. Branda, Rochester, MN (US); Kristi P. Peterson, Rochester, MN (US); John J. Stecher, Rochester, MN (US); Matthew R. Weaver, Rochester, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: International Business Machines Corporation, Armonk, NY (US)

(21) Appl. No.: 11/380,226

(22) Filed: Apr. 26, 2006

(51) Int. Cl. H04M 11/04

(52) U.S. Cl. 455/404.1

(57) ABSTRACT

An emergency notification feature for a mobile station calls for automatically and periodically activating the mobile station and polling a wireless communications network for emergency messages. Notice of an emergency is provided to a user of the mobile station through at least one of a ring tone and an automatic call-back.

### BACKGROUND OF THE INVENTION

1. Field of the Invention

This invention relates to use of a cell phone as an emergency communications device.

2. Description of Background

One of the nice things about cell phones is that they make it easier to get in contact with someone in the event of an emergency. However if the person you need to get in contact with has powered off their cell phone or let the battery run dead, it will be impossible to get a message conveyed immediately. In this situation, the best one can do is to leave a message and wait for a call back. This illustrates one of the current problems with using cell phones as emergency contact devices.

Improvements to cell phone technology are needed to provide emergency contacting features. Preferably, the emergency contact features make contacting a user of a cell phone possible in spite of the fact that the cell phone may be turned off or out of power.

### SUMMARY OF THE INVENTION

Disclosed is a method for providing notification of an emergency, the method including automatically and periodically activating a mobile station and periodically polling a wireless communications network for emergency messages; wherein upon identification of at least one emergency notification message, the mobile station provides the notification of the emergency to a user of the mobile station; and, otherwise, automatically deactivating the mobile station.

Also disclosed is a mobile station for providing notification of an emergency, the mobile station including an emergency notification feature for automatically and periodically activating the mobile station and polling the wireless communications network for emergency messages; wherein upon identification of at least one emergency message, the mobile station provides notification of the emergency message to a user of the mobile station.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which includes a computer program product stored on machine readable media, the product having instructions for providing notification of an emergency, the instructions providing instructions for: automatically and periodically activating a mobile station and polling a wireless communications network for emergency messages; wherein activating includes activating at least one of a main power supply and a reserve power supply; wherein a time interval for the periodically activating is selected by a user through use of at least one of the mobile station, an operator and a user access; wherein the wireless communications network is one of a cellular network, a radio network and a satellite network; wherein upon identification of at least one emergency notification message, the mobile station provides the notification of the emergency to a user of the mobile station by at least one of initiating a ring tone and a call-back; and, otherwise, automatically deactivating the mobile station.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a wireless communications network; and,

FIG. 2 illustrates one example of a method for managing an emergency notification feature.

The detailed description explains the preferred embodiments of the invention, together with advantages and features, by way of example with reference to the drawings.

### DETAILED DESCRIPTION OF THE INVENTION

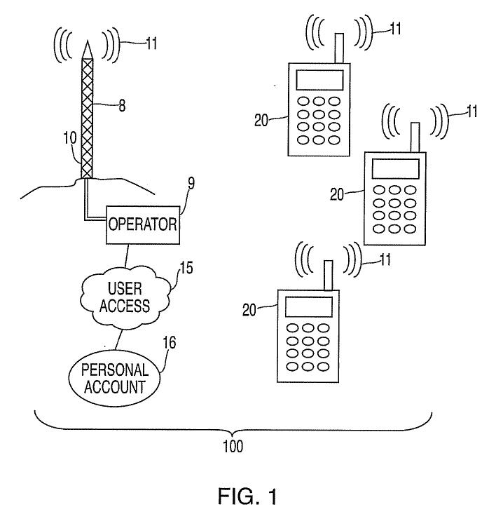

Referring now to FIG. 1, a wireless communications network 100 includes at least one base station 10 and a plurality of mobile stations 20. The base station 10 and the mobile stations exchange information by transmission and receipt of wireless signals 11. Typically, the wireless communications network 100 is a cellular network, however, other networks may be used equally well with the teachings herein. Another exemplary system includes a radio or “walkie-talkie” style network, while yet another system includes a satellite based system.

Typically, the base station 10 includes a tower 8 that is coupled to an operator 9. The operator 9 includes systems necessary for call management or communications management. The systems typically include an assortment of support personnel, computer hardware, computer software and power supplies as well as other devices as may be desired for operation of the communications network 100. In typical embodiments, a user of a selected mobile station 20 is provided access to and control over the emergency notification feature though the operator 9. Exemplary types of access include personal accounts 16 accessible through user access 15, such as the Internet.

The teachings herein provide a feature for maintaining an emergency notification function as a feature of a wireless communications network 100. Aspects of the emergency notification feature may be controlled at any point deemed convenient to users or system designers. For example, the emergency notification feature may be initiated, modified or terminated through use of one or more of the operator 9, the user access 15 and the mobile station 20.

As an example, the emergency notification feature provides a function where a mobile station 20 will at least partially power up (i.e., activate) at a periodic interval. In some embodiments, the period for activation is once every thirty minutes. When the mobile station 20 activates, a communication link between the base station 10 and the mobile station 20 is temporarily established. When the communication link is established, the mobile station 20 performs typical registration operations and receives notice of any emergency communications.

In typical embodiments, control over the emergency notification feature calls for selecting a period. For example, when using access through a personal account 16, the user may login to the personal account 16 via user access 15 such as the Internet. Once the personal account 16 is accessible, the user selects a time interval for periodic polling of the wireless communications network 100. Once the mobile station 20 is registered on the wireless communications network 100, the time interval is typically downloaded to the mobile station 20 and stored in a storage.

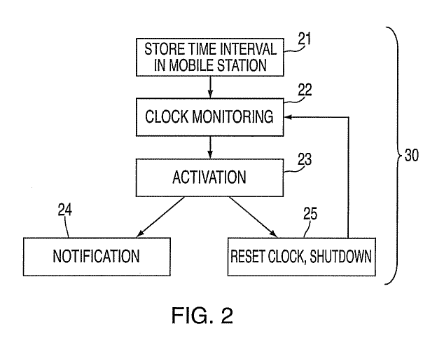

FIG. 2 depicts an exemplary method for operation of the emergency notification features. In FIG. 2, emergency message monitoring 30 first calls for storing the time interval 21 in the mobile station 20. In some embodiments, the time interval is selected and then downloaded, while in some other embodiments, the time interval is selected and stored by manipulation of controls for the mobile station 20.

Once the time interval has been stored, and the mobile station 20 is shutdown, clock monitoring 22 commences. In clock monitoring 22, the mobile station, using appropriate software, monitors a system clock and a register maintaining the time interval. During activation 23, the mobile station 20 at least partially powers up and then checks for emergency messages, all on an automatic basis. When emergency messages are identified, the mobile station 20 provides notification 24 to users in any manner desired. Alternatively, if emergency messages are not identified, the mobile station 20 resets a count down clock, powers down and returns to clock monitoring 22.

Typically, the resident software in the mobile station 20 that monitors the count down clock and the time interval includes instructions for partial activation and other power management and conservation features as desired.

By way of example, consider an instance where someone's father had a heart attack and was on his way to the hospital. If the son or daughters cell phone was turned off, the son or daughter would be unreachable. In the prior art, emergency notification would simply constitute leaving a voice-mail and then waiting for a return call. By making use of the teachings herein, a caller could choose an option to leave an emergency contact message. Soon thereafter, the son's or daughter's mobile station 20 would power up and check the wireless communications network 100 for emergency messages. When the emergency message was detected, the mobile station 20 would provide notification 24.

In some embodiments, providing notification 24 calls for automatic initiation of call back in addition to providing a ring tone. In such embodiments, emergency communications are established in a most expedient fashion.

Further aspects of typical mobile stations 20 may be taken advantage of to support the emergency notification feature. For example, selected ring tones could be exclusively associated with an emergency.

Typically, a mobile station 20 includes at least one battery as a power supply. In some embodiments, the power supply includes a reserve battery. In embodiments using a reserve battery, the mobile station 20 may apply the reserve to certain limited or preselected functions. In the case where a main battery of the mobile station 20 has been dissipated, the mobile station 20 could make use of the reserve battery for fulfilling the emergency notification function.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may male various improvements and enhancements which fall within the scope of the claims which follow. These claims should be construed to maintain the proper protection for the invention first described.

What is claimed is:

1. A method for providing notification of an emergency, the method comprising:
automatically and periodically activating a mobile station and periodically polling a wireless communications network for emergency messages;
wherein upon identification of at least one emergency notification message, the mobile station provides the notification of the emergency to a user of the mobile station; and, otherwise,
automatically deactivating the mobile station.

2. The method as in claim 1, wherein a period is selected by a user through using at least one of the mobile station, an user access and an operator.

3. The method as in claim 1, wherein the wireless communications network comprises one of a cellular network, a radio network and a satellite network.

4. The method as in claim 1, wherein providing notification comprises at least one of activating a ring tone and initiating a call back.

5. The method as in claim 1, wherein activating comprises using a reserve power supply.

6. A mobile station for providing notification of an emergency, the mobile station comprising:
an emergency notification feature for automatically and periodically activating the mobile station and polling the wireless communications network for emergency messages; wherein upon identification of at least one emergency message, the mobile station provides notification of the emergency message to a user of the mobile station.

7. The mobile station as in claim 1, wherein the emergency notification feature comprises a time interval for the periodically activating.

8. The mobile station as in claim 1, wherein the mobile station comprises a reserve power supply for the periodically activating.

9. A computer program product stored on machine readable media, the product comprising instructions for providing notification of an emergency, the instructions comprising instructions for:
automatically and periodically activating a mobile station and polling a wireless communications network, for emergency messages;
wherein activating comprises activating at least one of a main power supply and a reserve power supply;
wherein a time interval for the periodically activating is selected by a user through use of at least one of the mobile station, an operator and a user access;
wherein the wireless communications network comprises one of a cellular network, a radio network and a satellite network;
wherein upon identification of at least one emergency notification message, the mobile station provides the notification of the emergency to a user of the mobile station by at least one of initiating a ring tone and a call-back; and, otherwise,
automatically deactivating the mobile station.
